(19) United States
(12) Patent Application Publication
(10) Pub. No.: US 2005/0181259 A1
(43) Pub. Date: Aug. 18, 2005

(54) Fuel cell architecture

(75) Inventor: Guillaume Roberge, Bourgoin (FR)

Correspondence Address: Linda K. Russell, Suite 1800, 2700 Post Oak Blvd., Houston, TX, 77056, US

(73) Assignees: L'Air Liquide, Societe Anonyme a Directoire et Conseil du Surveillance pour l'Etude et; l'Exploitation des Procedes Georges Claude

(21) Appl. No.: 11/058,954

(22) Filed: Feb. 16, 2005

(30) Foreign Application Priority Data
Feb. 17, 2004 (FR) 0450289

(51) Int. Cl. H01M 8/02; H01M 8/24

(52) U.S. Cl. 429/34; 429/26; 429/32

(57) ABSTRACT

A fuel cell apparatus. The cell is made of elementary cells, themselves made of carbon-based bipolar plates. The plates closely surround a membrane and are in contact with an aluminum surface. The aluminum surface is coated with a thin, nickel based layer which is commonly produced by electroplating.

The present invention relates to fuel cells of the type comprising a stack of at least one structure of carbon-based bipolar plates tightly surrounding a membrane and in contact, on another face, with at least one metal plate made of aluminum.

Fuel cells, in particular of the proton exchange polymer membrane (PEM) type, conventionally comprise a stack of elementary cells arranged next to one another in an assembly commonly called a “pack”, in which the anodic or cathodic bipolar plates intended to convey the reactive gases on either side of the membrane are generally carbon (graphite or composite) based, which poses problems in establishing good electrical connection, in particular electrical contact with conducting metals, in particular aluminum.

An object of the present invention is to propose a fuel cell architecture that makes it possible to overcome these problems and to widely use aluminum in the manufacture of several elements of the fuel cell pack. To do this, according to a characteristic of the invention, the aluminum plate is coated with a nickel-based layer having a thickness not exceeding 50 μm, typically of between 20 and 30 μm.

The applicant has in fact noted, surprisingly, that the nickel plating of aluminum plates makes it possible to produce, and to maintain during use, excellent electrical contacts between the aluminum thus coated and carbon-based structures.

With such an arrangement, according to more specific characteristics of the invention:
the metal plate is a thick current-collecting plate and/or constitutes a face of a cooling cell, advantageously comprising means of connection to a cooling fluid circuit.

Other characteristics and advantages of the present invention will emerge from the following description of an embodiment, given by way of illustration but in no way limiting, realized in relation to the attached drawing, in which:
the single FIGURE represents diagrammatically, in an exploded perspective view, components of a fuel cell architecture according to the invention.

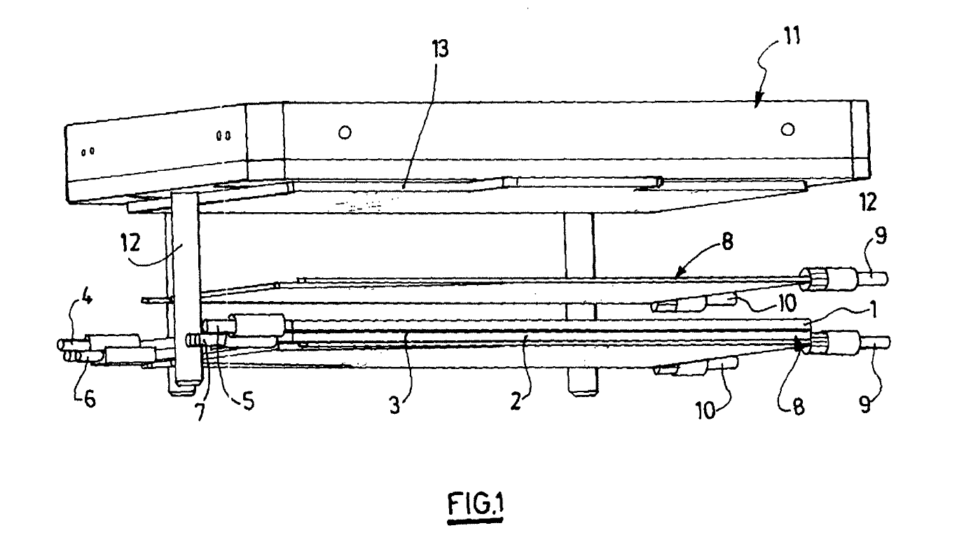

FIG. 1 shows an emementary cell of a fuel cell, consisting of a sandwich of two bipolar plates 1 and 2 tightly surrounding a polymer membrane 3 coated with a catalyst. The pack comprises a plurality (typically at least ten) of such elementary cells.

The anode plate 1 comprises a hydrogen inlet and a hydrogen outlet, 4 and 5 respectively, the cathode plate comprising air inlets and outlets, 6 and 7 respectively.

In the embodiment represented, each emementary cell is sandwiched between two cooling cells 8 formed by two adjacent aluminum plates delimiting between them channels or chambers of fluid, and each provided with an inlet and an outlet for cooling fluid, 9 and 10 respectively, typically oil, advantageously an alpha-olefin.

The stack of emementary cells 1-3 and of cooling cells 8 is maintained pressed between two endplates 11, just one of which is represented in FIG. 1, while being maintained laterally by peripheral studs 12. Each endplate 11 is associated, via an insulating plate 12, with a thick metal collecting plate 13, connected to an electrical cable (not represented).

According to one aspect of the invention, the bipolar plates 1 and 2, defining the channels for conveying the reactive gases on either side of the membrane 3, are made of carbon, the channels being obtained by molding and/or by machining.

According to the invention, the endplate 12 and the cooling cells 8 are made of aluminum, at least their flat contact faces being coated with a thin layer of nickel, having a globular structure, typically not exceeding 50 μm, advantageously having a thickness of between approximately 20 μm and 30 μm, deposited by electroplating, typically according to a process such as that used for the lugs of electrical cables, under the trade name NICALEC by the company TECHNIQUE SURFACES in Evry (France).

The applicant has noted that, with a thin nickel-plated interface, the contact resistance between carbon and aluminum is less than 5 milliohms/cm², typically less than 3 milliohms/cm², which, for a high current density, of the order of 1 A/cm², brings about, at the interface, a voltage drop of less than 5 mV, typically less than 3 mV, which is perfectly acceptable for an elementary cell at the edges of which the potential difference does not drop below 500 mV.

Although the invention has been described in relation to specific embodiments, it is not limited by these, but is liable to modifications and to variants which will become apparent to those skilled in the art in the context of the claims hereinafter.

1-7. (canceled)

8. An apparatus which may be used as a fuel cell, said apparatus comprising:
a) a membrane;
b) a structure comprising at least one carbon-based bipolar plate, wherein said structure closely surrounds said membrane; and
c) at least one aluminum plate, wherein said aluminum plate:
1) is in contact with said structure; and
2) is coated with a nickel-based layer, wherein said layer has a thickness of less than about 50 μm.

9. The apparatus of claim 8, wherein said thickness is between about 20 μm and about 30 μm.

10. The apparatus of claim 8, wherein said layer is formed by electroplating.

11. The apparatus of claim 8, wherein said aluminum plate is a thick current-collecting plate.

12. The apparatus of claim 8, wherein said aluminum plate is a face of a cooling cell.

13. The apparatus of claim 12, wherein said cooling cell comprises a connection means for connecting to a cooling fluid circuit.

14. The apparatus of claim 13, wherein said cooling fluid is an alpha-olefin fluid.

15. An apparatus which may be used as a fuel cell, said apparatus comprising:
a) a membrane;
b) a structure comprising at least one carbon-based bipolar plate, wherein said structure closely surrounds said membrane; and
c) at least one aluminum plate, wherein said aluminum plate:
1) is in contact with said structure;
2) is coated with a nickel-based layer, wherein said layer is formed by electroplating and has a thickness between about 20 μm and about 30 μm; and
3) is a thick current-collecting plate.

16. An apparatus which may be used as a fuel cell, said apparatus comprising:
a) a membrane;
b) a structure comprising at least one carbon-based bipolar plate, wherein said structure closely surrounds said membrane; and
c) at least one aluminum plate, wherein said aluminum plate:
1) is in contact with said structure;
2) is coated with a nickel-based layer, wherein said layer has a thickness of less than about 50 μm; and
3) is a face of a cooling cell, wherein said cooling cell comprises a connection means for connecting to a cooling fluid circuit, and wherein said cooling fluid is an alpha-olefin fluid.
